(19) United States
(12) Patent Application Publication
(10) Pub. No.: US 2013/0166055 A1
(43) Pub. Date: Jun. 27, 2013

(54) PRODUCTION SCHEDULE CREATING METHOD AND APPARATUS THEREFOR

(71) Applicants: Hisaya Ishibashi, Yokohama (JP); Takahiro Nakano, Fujisawa (JP); Satoshi Nagahara, Yokahama (JP)

(72) Inventors: Hisaya Ishibashi, Yokohama (JP); Takahiro Nakano, Fujisawa (JP); Satoshi Nagahara, Yokahama (JP)

(21) Appl. No.: 13/806,811

(22) PCT Filed: Jun. 20, 2011
(86) PCT No.: PCT/JP2011/064015

§ 371 Date: Jan. 22, 2013

(30) Foreign Application Priority Data
Sep. 9, 2010 (JP) 2010-201886

(51) Int. Cl. G06F 17/00

(52) U.S. Cl. CPC G06F 17/00
USPC 700/100

(57) ABSTRACT

The present invention provides a production schedule creating apparatus that acquires daily operation record for each process and changes the production sequence so as to instruct an operation in order to meet due date. A production schedule creating method plans a production schedule of a production process. The production process includes a plurality of operation processes. The production schedule creating method estimates a future status of delivery delay using a current status of the production process, performs a production simulation using a plurality of dispatching rules on a production process where the future delivery delay is estimated by the estimation, selects the most appropriate dispatching method with respect to a threshold value of a production management index of an on-time delivery rate and total overtime hours based on a result of the performed production simulation, and provides a production instruction to the production process using the selected dispatching method.

### BACKGROUND OF THE INVENTION

1. Field of the Invention

The present invention relates to a production schedule creating method that creates a production schedule with high accuracy in a short time for a planning operation of a production schedule of a make-to-order product such as an industrial machine, a motor, and an elevator. The present invention also relates to an apparatus for this method.

2. Description of the Related Art

In the case of make-to-order products such as an industrial machine, a motor, and an elevator, it is important to create a production schedule so as to produce and deliver the product by due date requested by a client. Conventionally, a technique for creating a production schedule utilizes a production line simulator to evaluate production capacity of each production line. Then, the technique has been creating a production schedule to meet due date of the client. For example, Japanese Patent Application Laid-Open Publication No. 2003-288476 employs a production line simulator for a semiconductor product as a target to evaluate production capacity of a production line, thus creating a production schedule and a production instruction.

However, in the case where a difference occurs between the production schedule and the operation record due to variation in operation time, arrival delay of a component, and a similar reason, this may cause delivery delay. In this case, a process sequence of operations in progress for each process is changed to meet due date. This is called dispatching. The dispatching method includes a First-In First-Out (FIFO) method that processes an operation on an earlier arrival time, a Shortest Process-ing Time (SPT) method that processes an operation with shorter processing time, an Earliest Due Date (EDD) method that processes an operation closer to the due date, and a similar method. For example, Japanese Patent Application Laid-Open Publication No. 2004-295679 employs a critical ratio method that sequentially processes an operation with a smaller critical ratio, which is calculated with a ratio of time remaining until due date to remaining processing time until completion of the final process as a production instruction method, thus eliminating delivery delay.

However, the make-to-order products such as an industrial machine, a motor, an elevator, and an escalator have different product specifications depending on an order of the client. It is rare to repeatedly produce the same component. Some products with the same name may each have a different design specification, and have a different operation time and a different process to be operated. Accordingly, in order to meet due date, it is preferred to acquire a daily operation record for each process and change the production sequence to instruct an operation.

In contrast, in the case where the production line simulator in Japanese Patent Application Laid-Open Publication No. 2003-288476 is used to change the production sequence, addition of a resource such as overtime hours allows eliminating progress delay. However, this method plans the production schedule of all processes again after changing the production sequence. This takes a long calculation time and is not practical.

The dispatching method in Japanese Patent Application Laid-Open Publication No. 2004-295679 determines a process sequence operation in progress of the target process. Its calculation time is short, which is an advantage. However, production capacity after this process is not considered. Thus, a problem arises in that delivery delay may occur when the determined process sequence is performed. Additionally, the dispatching method has a different aim such as an aim focusing on due date and an aim focusing on throughput depending on a type of the selected dispatching method. This changes influence on the production line. Accordingly, it is difficult for operator of the production schedule to select an appropriate dispatching method correspond to production status.

### SUMMARY OF THE INVENTION

The present invention has been made to solve the above-described problems, and it is an object of the present invention to provide a production schedule creating method that acquires daily operation record for each process and change the production sequence to instruct an operation in order to meet due date. Another object of the present invention is to provide an apparatus for this method.

In order to achieve the aforementioned objects, a production schedule creating apparatus according to the present invention plans a production schedule of a production process. The production process includes a plurality of operation processes. The production schedule creating apparatus includes a delivery delay detection simulation unit, a dispatching rule information storage unit, a production schedule creating unit, a production schedule evaluating unit, and a dispatching instruction unit. The delivery delay detection simulation unit is configured to estimate a future status of delivery delay using a current status of the production process. The dispatching rule information storage unit is configured to register a plurality of dispatching rules. The production schedule creating unit is configured to use the plurality of dispatching rules registered in the dispatching rule information storage unit, so as to perform a production simulation of the production process where the future delivery delay is estimated by the delivery delay detection simulation unit. The production schedule evaluating unit is configured to select a most appropriate dispatching method with respect to a threshold value of a production management index such as an on-time delivery rate and total overtime hours based on a result of the production simulation performed by the production schedule creating unit. The dispatching instruction unit is configured to provide a production instruction to the production process using the dispatching method. The dispatching method is selected by the production schedule evaluating unit.

Further, in order to achieve the aforementioned objects, a production schedule creating method according to the present invention plans a production schedule of a production process. The production process includes a plurality of operation processes. The production schedule creating method estimates a future status of delivery delay using a current status of the production process, performs a production simulation using a plurality of dispatching rules on a production process where the future delivery delay is estimated by this estimation, selects a most appropriate dispatching method with respect to a threshold value of a production management index such as an on-time delivery rate and total overtime hours based on a result of the performed production simulation, and provides a production instruction to the production process using the selected dispatching method.

The present invention minimizes operation time to be added in the event that delivery delay of the make-to-order product such as an industrial machine, a motor, an elevator, and an escalator occurs. This allows accurately creating a production schedule in a short time to meet due date.

### BRIEF DESCRIPTION OF DRAWINGS

FIG. 1 is a block diagram illustrating a schematic configuration of a production schedule creating system as one embodiment according to the present invention;

FIG. 2 is a block diagram illustrating a schematic configuration of a production schedule creating apparatus as one embodiment according to the present invention;

FIG. 3 is a table illustrating order information as one embodiment according to the present invention;

FIG. 4 is a table illustrating work-in-progress information as one embodiment according to the present invention;

FIG. 5 is a table illustrating operation record information as one embodiment according to the present invention;

FIG. 6 is a table illustrating process route information as one embodiment according to the present invention;

FIG. 7 is a table illustrating facility operation information as one embodiment according to the present invention;

FIG. 8 is a table illustrating dispatching rule storing information as one embodiment according to the present invention;

FIG. 9 is a block diagram illustrating a hardware configuration as one embodiment according to the present invention;

FIG. 10 is a flowchart illustrating an operation process of the production schedule creating apparatus as one embodiment according to the present invention;

FIG. 11 is a flowchart illustrating a detailed operation process of Step S20 in the flowchart of FIG. 10;

FIG. 12 is a flowchart illustrating a detailed operation process of Step S30 in the flowchart of FIG. 10;

FIG. 13 is a front view of a screen that outputs a process result as one embodiment according to the present invention;

FIG. 14 is a front view of a screen that outputs a process result as one embodiment according to the present invention;

FIG. 15 is a front view of a screen that outputs a process result as one embodiment according to the present invention;

FIG. 16 is a front view of a screen that outputs a process result as one embodiment according to the present invention; and

FIG. 17 is a front view of a screen that outputs a process result as one embodiment according to the present invention.

### DESCRIPTION OF THE PREFERRED EMBODIMENTS

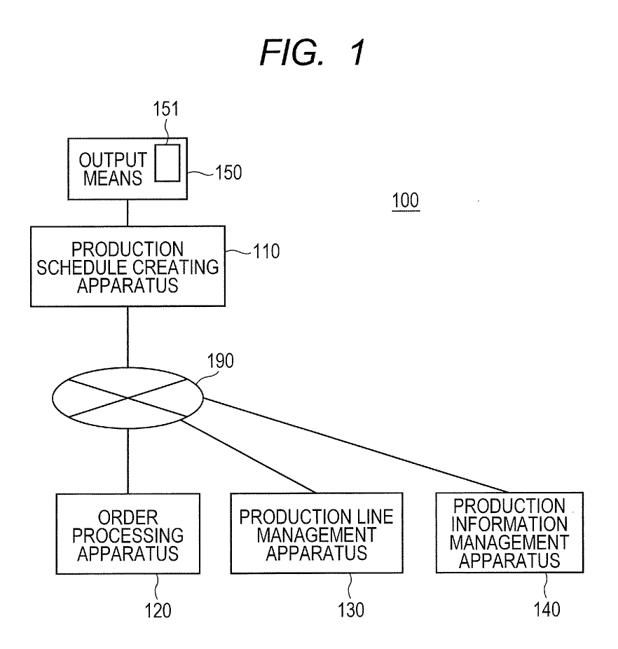

A description will be given of one embodiment according to the present invention below. FIG. 1 is a schematic diagram of a production schedule creating system 100 according to the present invention as one embodiment according to the present invention. As illustrated in the drawing, the production schedule creating system includes a production schedule creating apparatus 110, an order processing apparatus 120, a production line management apparatus 130, and a production information management apparatus 140. These members can mutually send and receive information through a network 190. The production schedule creating system 100 includes an output means 150 that outputs a process result of the production schedule creating apparatus 110 on a screen 151.

The order processing apparatus 120 receives an order from a client, and controls order information such as product specification, client information, and due date. The order processing apparatus 120 sends the received order information to the production schedule creating apparatus 110 at a predetermined timing or corresponding to a request from the production schedule creating apparatus 110. One production line management apparatus 130 may control operation record information of all production lines. Multiple production line management apparatuses 130 may be installed corresponding to the number of production lines. Then, the production line management apparatus 130 sends the operation record information to the production schedule creating apparatus 110 at a predetermined timing or corresponding to a request from the production schedule creating apparatus 110. The production information management apparatus 140 controls process route information such as production capacity for each process, a process route for each product, and an available facility for processing. The production information management apparatus 140 sends the production capacity and the process route information to the process design and production schedule creating apparatus 110 at a predetermined timing or corresponding to a request from the production schedule creating apparatus 110.

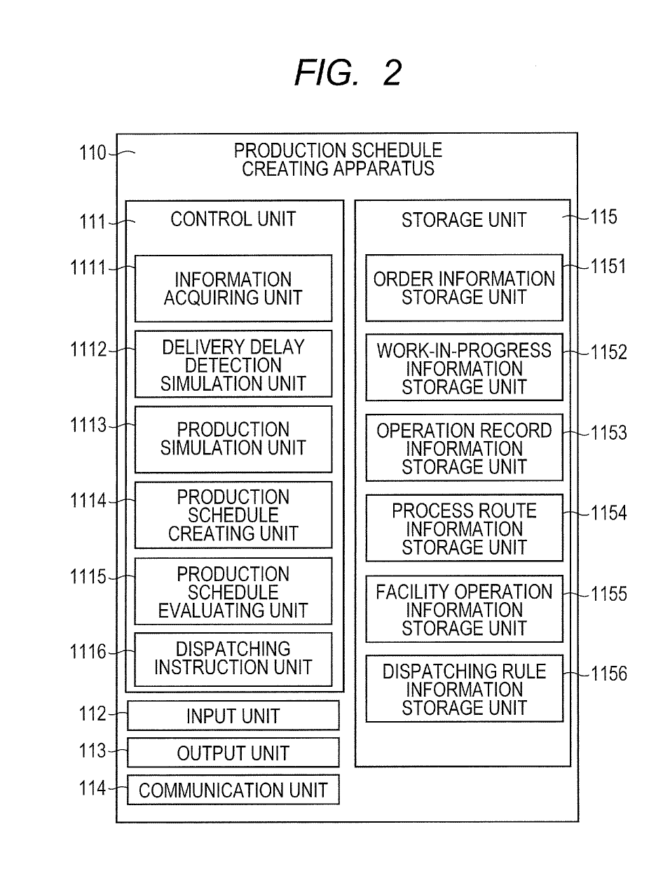

FIG. 2 is a schematic diagram of the production schedule creating apparatus 110. As illustrated in the drawing, the production schedule creating apparatus 110 includes a control unit 111, an input unit 112, an output unit 113, a communication unit 114, and a storage unit 115. The control unit 111 includes an information acquiring unit 1111, a delivery delay detection simulation unit 1112, a production simulation unit 1113, a production schedule creating unit 1114, a production schedule evaluating unit 1115, and a dispatching instruction unit 1116. The input unit 112 receives input information.

The output unit 113 outputs information. The communication unit 114 sends and receives information through the network 190. The storage unit 115 includes an order information storage unit 1151, a work-in-progress information storage unit 1152, an operation record information storage unit 1153, a process route information storage unit 1154, a facility operation information storage unit 1155, and a dispatching rule information storage unit 1156.

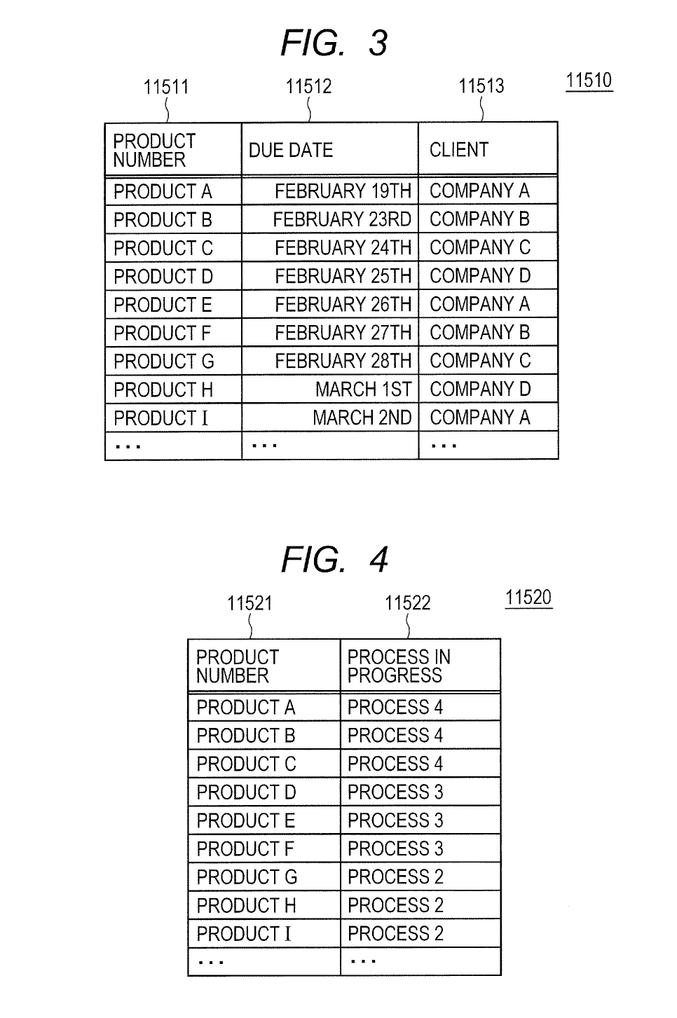

FIG. 3 is a table illustrating one embodiment of a file format 11510 of the order information storage unit 1151 in FIG. 2. In FIG. 3, the file format 11510 includes a field 11511 to register a product number, which is an identification number numbered when an order is received from a client as a delivery destination, a field 11512 to register due date when a product is delivered to a delivery destination, and a field 11513 to register a delivery destination of a client.

FIG. 4 is a table illustrating one embodiment of a file format 11520 of the work-in-progress information storage unit 1152 in FIG. 2. In FIG. 4, the file format 11520 includes a field 11521 to register a product number, which is an identification number numbered when an order is received from a client as a delivery destination, and a field 11522 to register a process in process where a target product is currently in process.

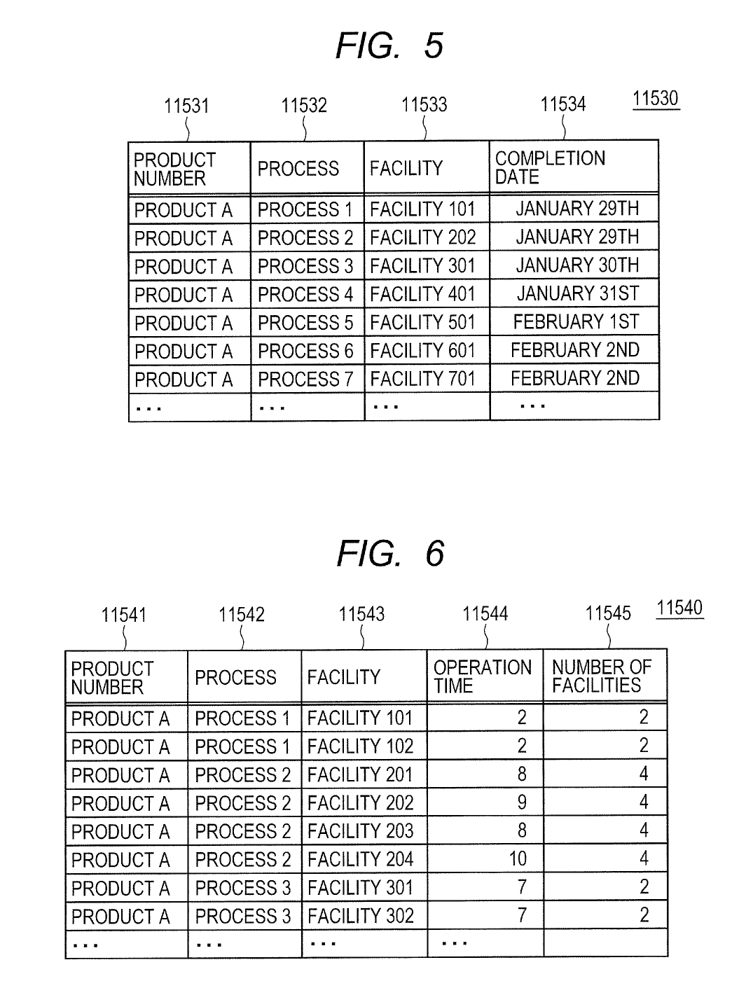

FIG. 5 is a table illustrating one embodiment of a file format 11530 of the operation record information storage unit 1153 in FIG. 2. In FIG. 5, the file format 11530 includes a field 11531 to register a product number, which is an identification number numbered when an order is received from a client as a delivery destination, a field 11532 to register a process that is completed in a production process of a target product, a field 11533 to register a facility name of the process that has completed the production process of the target product, and a field 11534 to register a time when the production process of the target product is completed.

FIG. 6 is a table illustrating one embodiment of a file format 11540 of the process route information storage unit 1154 in FIG. 2. In FIG. 6, the file format 11540 includes a field 11541 to register a product number, which is an identification number numbered when an order is received from a client as a delivery destination, a field 11542 to register a process for which a production process is required by a target product, a field 11543 to register a facility name of the process that performs the production process of the target product, a field 11544 to register a required time for the process with a target facility in the process that performs the production process of the target product, and a field 11545 to register the number of facilities for the process that performs the production process of the target product.

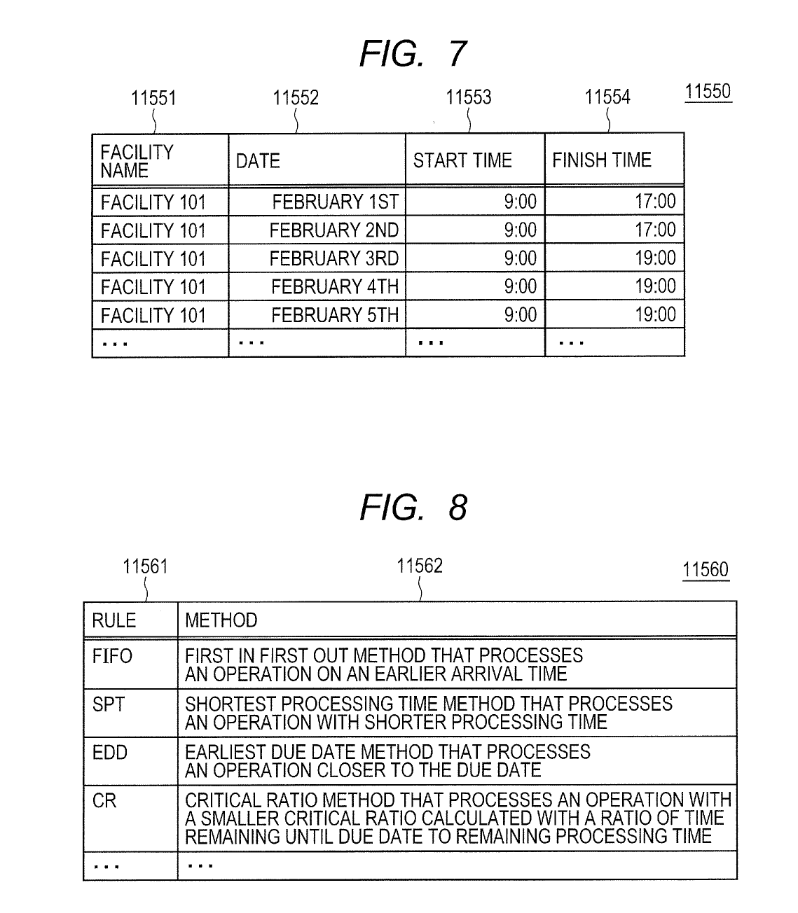

FIG. 7 is a table illustrating one embodiment of a file format 11550 of the facility operation information storage unit 1155 in FIG. 2. In FIG. 7, the file format 11550 includes a field 11551 to register a facility, a field 11552 to register date when a target facility operates, a field 11553 to register time when a target facility starts operating, and a field 11554 to register time when a target facility finishes operating.

FIG. 8 is a table illustrating one embodiment of a file format 11560 of the dispatching rule information storage unit 1156 in FIG. 2. In FIG. 8, the file format 11560 includes a field 11561 to register a name of a dispatching rule, and a field 11562 to register an explanation of a method of a dispatching rule.

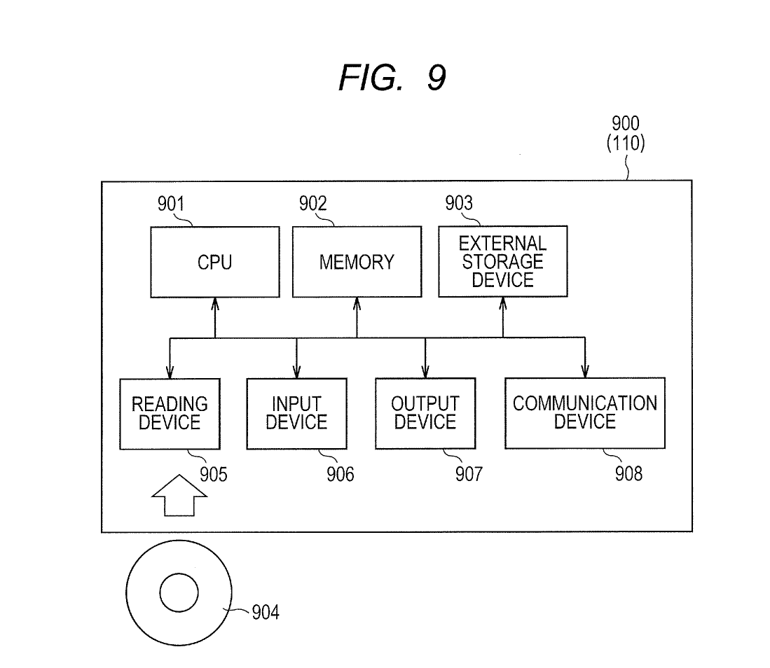

The production schedule creating apparatus 110 in FIG. 1 is achieved using a general computer 900. As illustrated in FIG. 9 (a schematic diagram of a computer 900), the computer 900 includes, for example, a Central Processing Unit (CPU) 901, a memory 902, an external storage device 903 such as a Hard Disk Drive (HDD), a reading device 905 that reads and writes information to a portable storage medium 904 such as a Compact Disk (CD) and a Digital Versatile Disk (DVD), an input device 906 such as a keyboard and a computer mouse, an output device 907 such as a display, and a communication device 908 such as a Network Interface Card (NIC) to be coupled to a communication network.

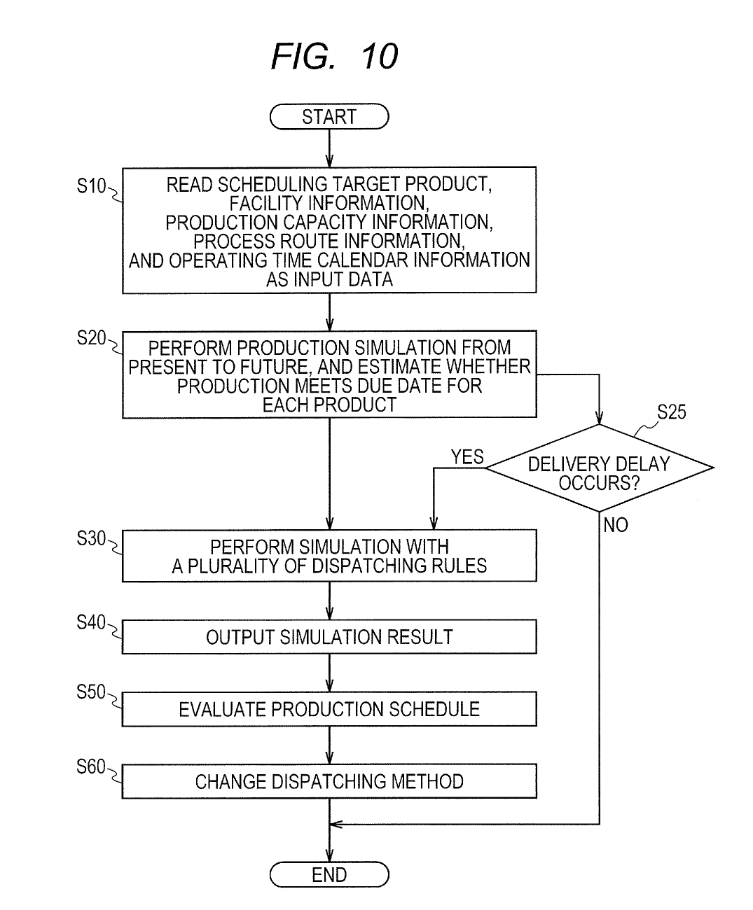

Next, a description will be given of a processing program executed by the production schedule creating apparatus 110 according to the present invention by referring to FIG. 10 in sequence.

FIG. 10 is a flowchart illustrating a process for creating a production schedule executed by the production schedule creating apparatus 110 according to the present invention.

First, the information acquiring unit 1111 of the control unit 111 reads scheduling target product, facility information, production capacity information, process route information, and operating time calendar information as input data from the storage unit 115 (S10).

Subsequently, the delivery delay detection simulation unit 1112 of the control unit 111 performs a production simulation from present to future based on the order information stored in the order information storage unit 1151, work-in-progress information stored in the work-in-progress information storage unit 1152, and an operation record stored in the operation record information storage unit 1153. Then, the delivery delay detection simulation unit 1112 estimates whether production meets due date for each product (S20). As a result of the estimation (S25), the process simply terminates in the case where delivery delay does not occur. In the case where delivery delay occurs, the process proceeds to Step S30.

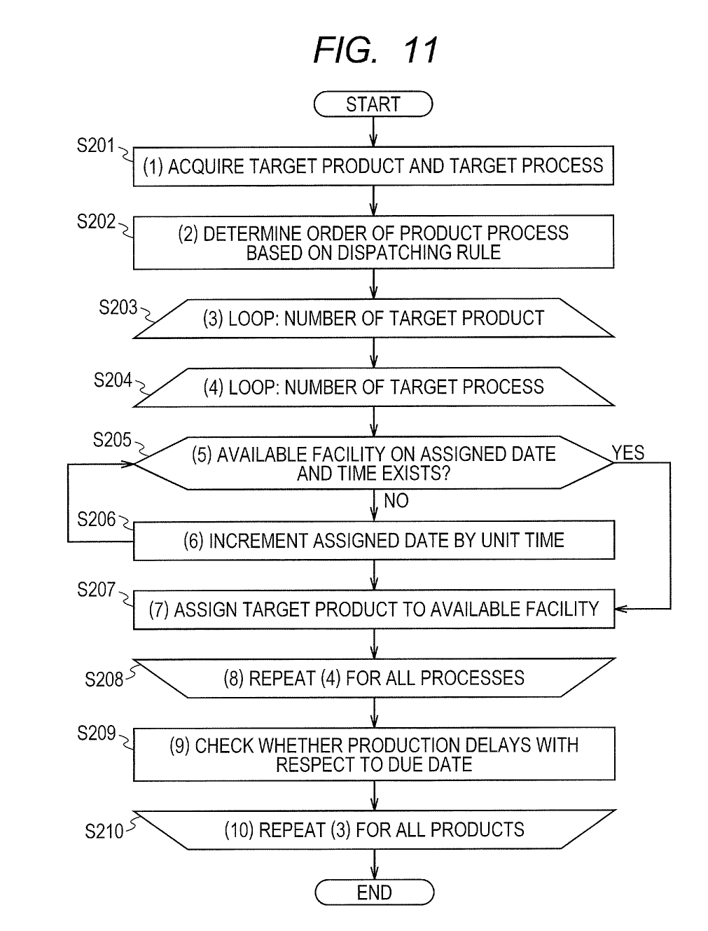

Step S20 will be described by referring to FIG. 11 in detail. Subsequently, in the case where it is determined that delivery delay occurs at S25, the production simulation unit 1113 of the control unit 111 calculates required production capacity to determine overtime hours and input timing. The production simulation unit 1113 performs a simulation with a plurality of dispatching rules to estimate whether delivery delay is eliminated (S30).

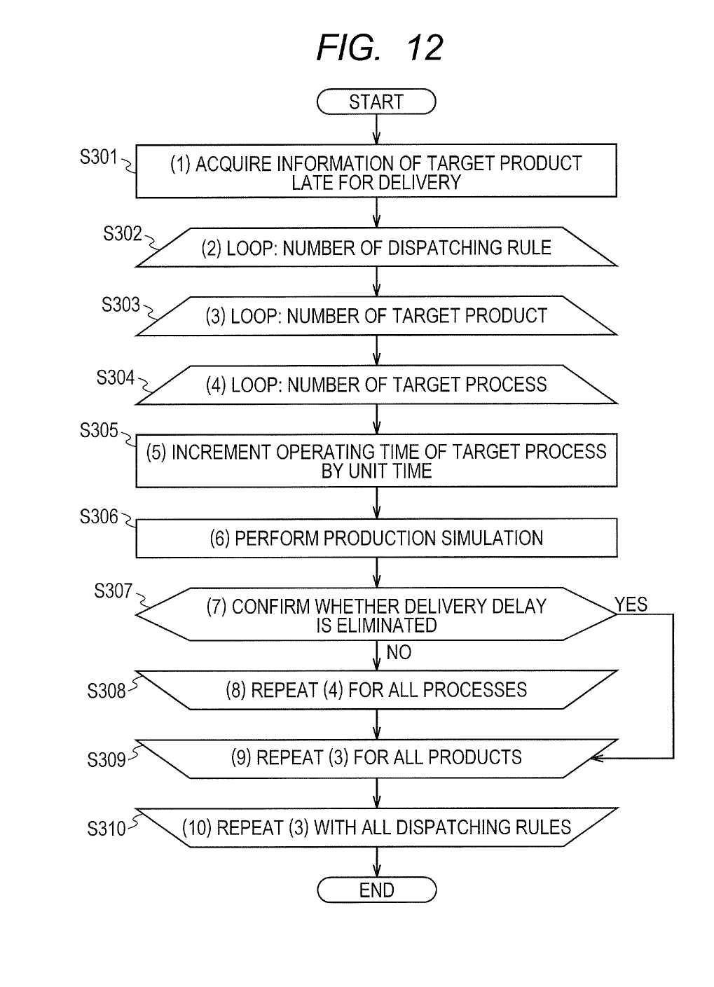

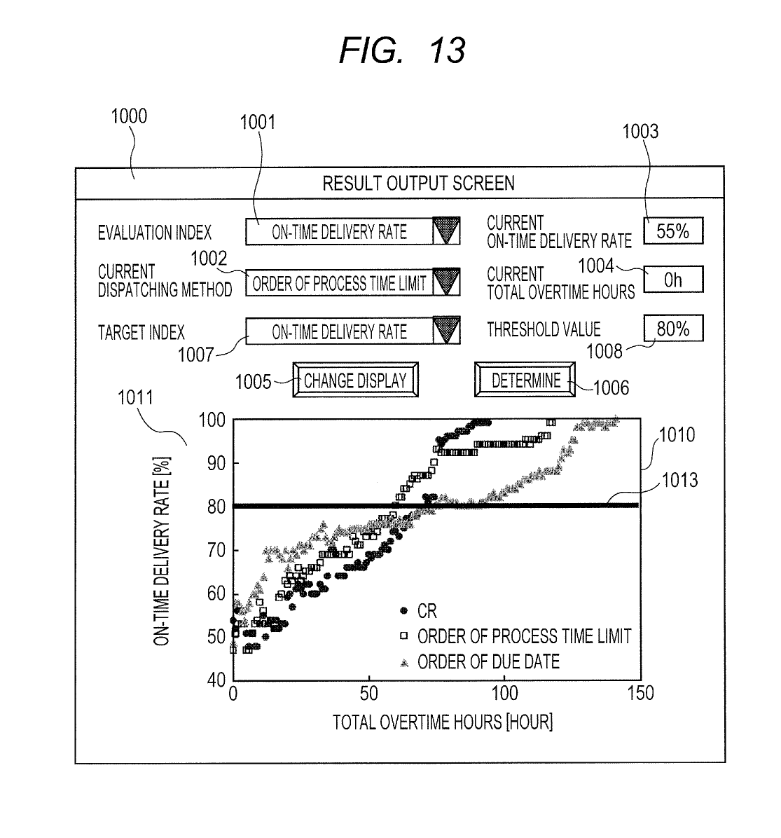

Step S30 will be described by referring to FIG. 12 in detail.

Subsequently, the production schedule creating unit 1114 of the control unit 111 outputs a simulation result, which is performed at Step S30, from the output unit 113 (S40).

The output result of Step S40 will be described by referring to FIGS. 13, 14, and 15 in detail.

Subsequently, the production schedule evaluating unit 1115 of the control unit 111 selects the most appropriate dispatching method for the output result at Step S40 using threshold values such as an on-time delivery rate, which is preliminarily set, and total overtime hours (S50).

Subsequently, the dispatching instruction unit 1116 of the control unit 111 sends the dispatching method, which is selected at Step S50, to the production line management apparatus 130 through the network 190, and changes dispatching methods of all apparatuses into the dispatching method selected this time (S60).

FIG. 11 is a flowchart illustrating a detailed process sequence that detects a delivery delay at Step S20 in FIG. 10.

First, the delivery delay detection simulation unit 1112 of the control unit 111 acquires information of a target product and a target process stored in the storage unit 115 (S201).

Subsequently, the delivery delay detection simulation unit 1112 determines an order of product process based on the dispatching rule (S202).

Subsequently, the delivery delay detection simulation unit 1112 repeats processes of Steps S204 to S209 for the number of all products in order to plan schedules of all products stored in the order information storage unit 1151 (S203).

Subsequently, the delivery delay detection simulation unit 1112 repeats processes of Steps S205 to S207 for the number of all processes in order to plan a schedule of the target product (S204).

Subsequently, the delivery delay detection simulation unit 1112 confirms whether an available facility exists on date and time assigned to the target product and the target process (S205).

Subsequently, the delivery delay detection simulation unit 1112 makes the process to proceed to Step S206 in the case where an available facility does not exist. The delivery delay detection simulation unit 1112 then increments the assigned date and time by unit time (S206). The process proceeds to Step S205. In the case where an available facility exists, the delivery delay detection simulation unit 1112 makes the process to proceed to Step S207. The delivery delay detection simulation unit 1112 then assigns the target product to the available facility, and increments the assigned date and time by the operating time (S207).

The delivery delay detection simulation unit 1112 repeats the processes of Steps S205 to S207 for the number of all processes in order to plan a schedule of the target product (S208). Finally, the delivery delay detection simulation unit 1112 checks whether delay of the target product with respect to due date occurs (S209).

The delivery delay detection simulation unit 1112 repeats the processes of Steps S204 to S209 for the number of all processes in order to plan schedules of all target products (S210).

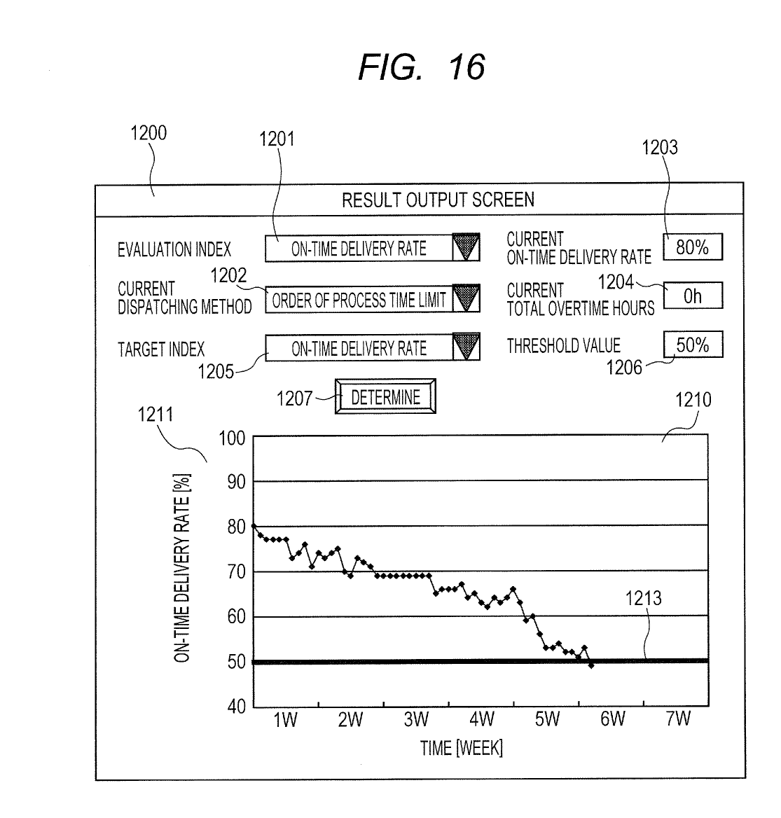

FIG. 16 is a schematic diagram illustrating an exemplary output screen 1200 output on the screen 151 of the output means 150. The output screen 1200 displays a graph 1210 where the vertical axis 1211 indicates the on-time delivery rate, which is an evaluation index selected by the selecting means 1201, and the horizontal axis 1212 indicates time where the current time is defined as zero. Accordingly, the output screen 1200 is a diagram that illustrates a result of the process at Step S20. An example in FIG. 16 illustrates as follows. The evaluation index selecting portion 1201 selects the on-time delivery rate. A current dispatching method selecting portion 1202 selects an order of process time limit. A target index setting portion 1205 selects the on-time delivery rate. The example in FIG. 16 also illustrates input items as follows. A current on-time delivery rate of 80% is input into a current on-time delivery rate displaying column 1203. A current total overtime hours of 0 h (zero hour) is input into a current total overtime hours displaying column 1204. A threshold value of 50% that is a target on-time delivery rate with respect to the on-time delivery rate selected by the target index selecting portion 1205 is input into a threshold value setting column 1206.

Clicking a determination button 1207 in a state where these conditions are selected and the respective input items are input allows performing the process at Step S20. As a result, a time change of the on-time delivery rate is displayed on the graph 1210. On the graph 1210, a thick line 1213 is displayed corresponding to the set threshold value.

FIG. 12 is a flowchart illustrating the process, which performs a simulation with a plurality of dispatching rules, at Step S30 in FIG. 10.

First, the production simulation unit 1113 acquires information stored in the storage unit 115 regarding the target product that is late for delivery at Step S20 (S301).

Subsequently, the production simulation unit 1113 repeats processes of Steps S303 to S309 based on the number of the dispatching rules stored in the dispatching rule information storage unit 1156 (S302).

Subsequently, the production simulation unit 1113 repeats processes of Steps S304 to S308 for the number of all target products that are late for delivery at Step S20 (S303).

Subsequently, the production simulation unit 1113 repeats processes of Steps S305 to S307 for the number of all processes in order to plan a schedule of the target product (S304).

Subsequently, the production simulation unit 1113 increments the operating time of the target product and the target process by unit time (S305).

Subsequently, the production simulation unit 1113 performs a production simulation (S306). At Step S306, for example, a process similar to the process that detects the delivery delay at Step S20 in FIG. 11 is performed.

Subsequently, the production simulation unit 1113 confirms the elimination of the delivery delay. In the case where the delivery delay is eliminated, the process proceeds to Step S309. In the case where the delivery delay is not eliminated, the process proceeds to Step S308 (S307).

The production simulation unit 1113 repeats the processes of Steps S305 to S307 for the number of all processes in order to plan a schedule of the target product (S308).

The production simulation unit 1113 repeats the processes of Steps S304 to S308 for the number of all processes in order to plan schedules of all target products (S309). The production simulation unit 1113 repeats the processes of Steps S303 to S309 with all the dispatching rules (S310).

Finally, an output of the simulation result of Step S40 will be described.

FIG. 13 is a schematic diagram illustrating an exemplary output screen 1000. The output screen 1000 displays an evaluation index selecting portion 1001, a current dispatching method selecting portion 1002, a target index setting portion 1007, a current on-time delivery rate displaying column 1003, a current total overtime hours displaying column 1004, and a threshold value setting column 1008. The output screen 1000 displays a graph 1010 of the simulation result. An example in FIG. 13 displays the graph 1010 where the vertical axis 1011 indicates the on-time delivery rate, which is an evaluation index selected by the evaluation index selecting portion 1001, and the horizontal axis 1012 indicates the total overtime hours added in the simulation due to a delivery delay. The output screen 1000 displays the result of Step S30 regarding three dispatching methods, which are FIFO, SPT, and Critical Ratio (CR), the order of process time limit, and the order of due date. The evaluation may employ an additional dispatching method such as FIFO and SPT.

Assume that in the output screen 1000 of FIG. 13, a target index selected between on-time delivery rate and total overtime hour, which are preliminarily set, is set as a target index of the target index setting portion 1007. A threshold value corresponding to the target index, which is set to the threshold value setting column 1008 by the target index setting portion 1007, is read out from the storage unit 115 and displayed. In the case where a user does not input anything to the threshold value setting column 1008 in this state, a condition preliminarily stored in the storage unit 115 is used. Clicking the determination button 1006 allows the production schedule evaluating unit 1115 to evaluate the production schedule based on the threshold value such as the on-time delivery rate and the total overtime hours, and then selects an appropriate dispatching method (S50). In this example, the target index setting portion 1007 is set to the on-time delivery rate while the threshold value setting column 1008 is set to 80%. Thus, the production schedule evaluating unit 1115 selects the order of process time limit as a dispatching method.

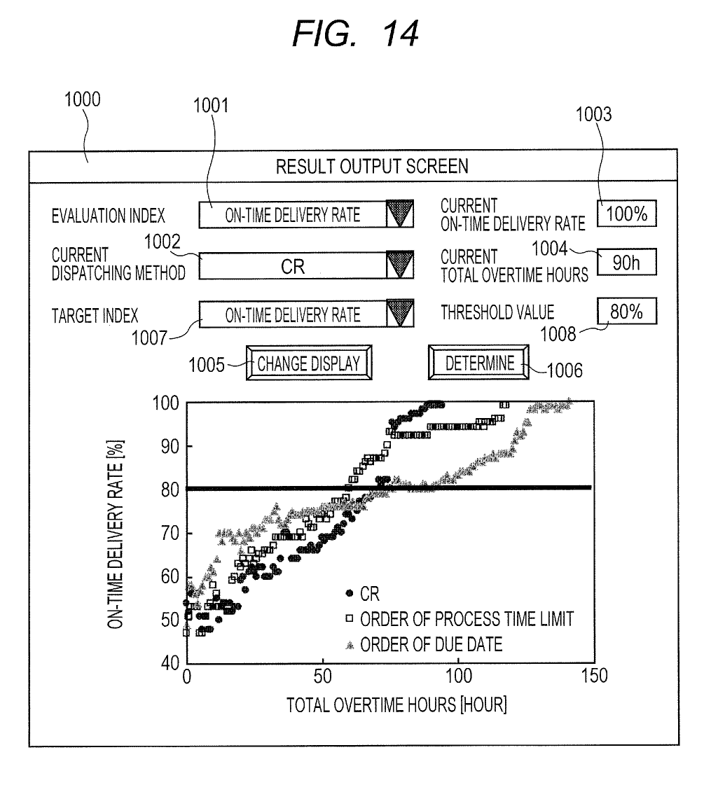

On the output screen 1000 in FIG. 13, 100% is input into the current on-time delivery rate input column 1003, and a change display button 1005 is clicked. This makes the production schedule evaluating unit 1115 to select CR, which has the highest on-time delivery rate among the three dispatching methods, as the most appropriate dispatching method. As illustrated in the output screen 1000 of FIG. 14, the current dispatching method column 1002 displays CR. The column of the current total overtime hours 1004 of the input items is set to overtime hours at this time of 90 hours as an input. In the case where the future production schedule is to be planned in this condition, a determination button 1006 is clicked. This allows changing the dispatching method from the current order of process time limit to CR. The overtime hours employs 90 hours.

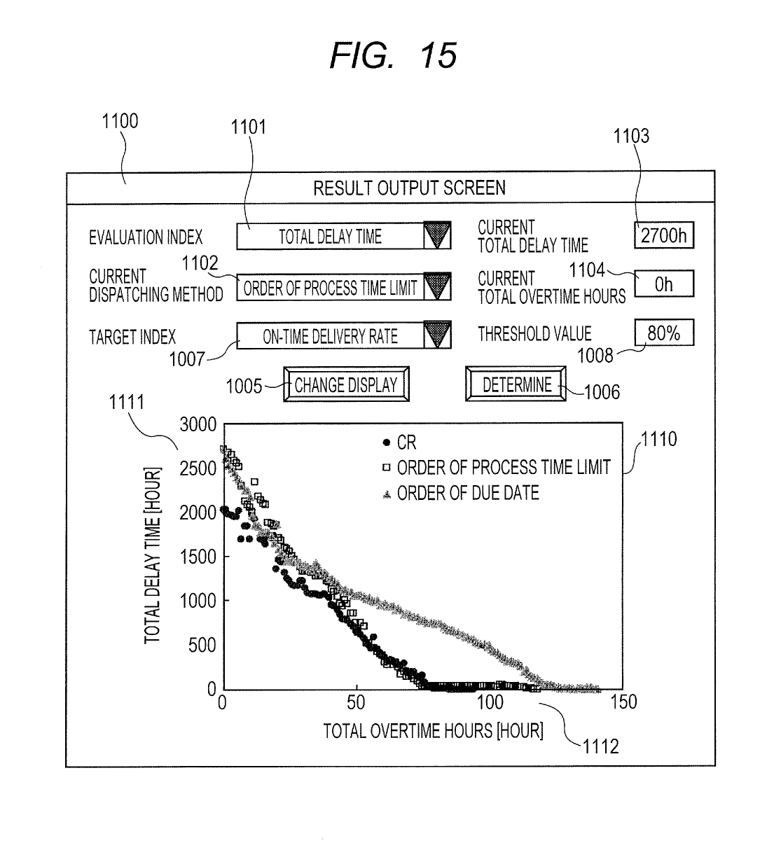

On the output screen 1000 in FIG. 13, in the case where the total delay time is selected in the evaluation index setting portion 1001, the screen changes into the output screen 1100 in FIG. 15. The output screen 1100 displays a graph 1110 where the vertical axis 1111 indicates the total delay time and the horizontal axis 1112 indicates the total overtime hours added in the simulation due to delivery delay. The output screen 1100 displays the result of Step S30 regarding three dispatching methods, which are Critical Ratio (CR), the order of process time limit, and the order of due date. A current dispatching method selecting portion 1102 displays the order of due date. A current total delay time input column 1103 displays the current total delay time of 2700 hours. A current total overtime hours input column 1004 displays the current total overtime hours of zero hour.

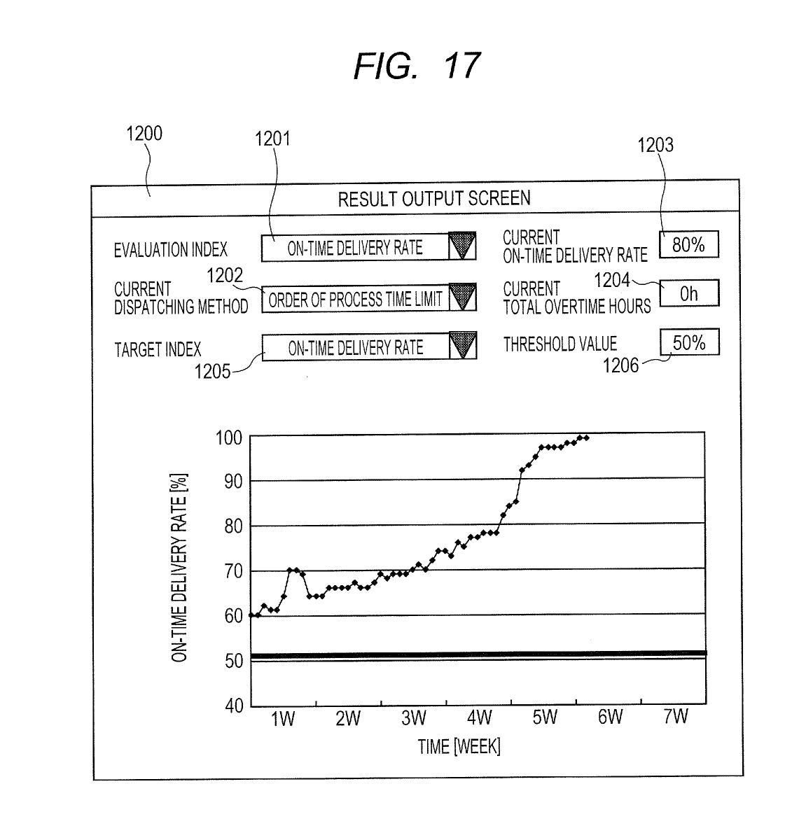

FIG. 17 is a schematic diagram of an exemplary output screen 1200. The output screen 1200 displays the vertical axis indicating the on-time delivery rate, which is an evaluation index selected by the selecting means 1201, and the horizontal axis indicating time where the current time is defined as zero. The output screen is a diagram where the dispatching rule is changed based on the result of the process at Step S60 and the delivery delay is estimated to be eliminated.

### REFERENCE SIGNS LIST

100 production schedule creating system
110 production schedule creating apparatus
111 control unit
112 input unit
113 output unit
114 communication unit
115 storage unit

What is claimed is:

1. A production schedule creating apparatus for planning a production schedule of a production process, the production process including a plurality of operation processes, the production schedule creating apparatus comprising:
a delivery delay detection simulation unit configured to estimate a future status of delivery delay using a current status of the production process;
a dispatching rule information storage unit configured to register a plurality of dispatching rules;
a production schedule creating unit configured to use the plurality of dispatching rules registered in the dispatching rule information storage unit, so as to perform a production simulation of the production process where the future delivery delay is estimated by the delivery delay detection simulation unit;
a production schedule evaluating unit configured to select a most appropriate dispatching method with respect to a threshold value of a production management index of an on-time delivery rate and total overtime hours based on a result of the production simulation performed by the production schedule creating unit; and
a dispatching instruction unit configured to provide a production instruction to the production process using the dispatching method, the dispatching method being selected by the production schedule evaluating unit.

2. The production schedule creating apparatus according to claim 1, further comprising a display unit with a display screen,
wherein the display unit is configured to display the future status of delivery delay in a graph format from the current status of the production process, the current status on the display screen of the production process being estimated by the delivery delay detection simulation unit.

3. The production schedule creating apparatus according to claim 2,
wherein the display unit is configured to display a result of the production simulation performed by the production schedule creating unit, and
the production schedule evaluating unit is configured to select a most appropriate dispatching method with respect to a threshold value of a production management index of an on-time delivery rate and total overtime hours, the production management index being set on the display unit where the result of the production simulation is displayed.

4. The production schedule creating apparatus according to claim 1,
wherein the display unit is configured to display results of production simulation obtained by a plurality of dispatching methods, the respective results being overlaid on a graph.

5. The production schedule creating apparatus according to claim 2,
wherein the display unit is configured to display results of production simulation obtained by a plurality of dispatching methods, the respective results being overlaid on a graph.

6. The production schedule creating apparatus according to claim 3,
wherein the display unit is configured to display results of production simulation obtained by a plurality of dispatching methods, the respective results being overlaid on a graph.

7. A production schedule creating method for planning a production schedule of a production process, the production process including a plurality of operation processes, the production schedule creating method comprising:
estimating a future status of delivery delay using a current status of the production process;
performing a production simulation using a plurality of dispatching rules on a production process where the future delivery delay is estimated by the estimation;
selecting a most appropriate dispatching method with respect to a threshold value of a production management index of an on-time delivery rate and total overtime hours based on a result of the performed production simulation; and
providing a production instruction to the production process using the selected dispatching method.

8. The production schedule creating method according to claim 7, further comprising:
displaying an estimation result of the future status of delivery delay in a graph format on a display screen from the current status of the production process.

9. The production schedule creating method according to claim 7, further comprising:
displaying a result of the performed production simulation on a display screen, and
selecting a most appropriate dispatching method with respect to a threshold value of a production management index of an on-time delivery rate and total overtime hours in the selecting of the dispatching method, the production management index being set on the display screen where the result of the production simulation is displayed.

10. The production schedule creating method according to claim 7, further comprising:
displaying results of production simulation obtained by the plurality of dispatching methods on a display screen, the respective results being overlaid on a graph.

11. The production schedule creating method according to claim 8, further comprising:
displaying a result of the performed production simulation on a display screen, and
selecting a most appropriate dispatching method with respect to a threshold value of a production management index of an on-time delivery rate and total overtime hours in the selecting of the dispatching method, the production management index being set on the display screen where the result of the production simulation is displayed.

12. The production schedule creating method according to claim 8, further comprising:
displaying results of production simulation obtained by the plurality of dispatching methods on a display screen, the respective results being overlaid on a graph.

13. The production schedule creating method according to claim 9, further comprising:
displaying results of production simulation obtained by the plurality of dispatching methods on a display screen, the respective results being overlaid on a graph.
